(19) United States
(12) Patent Application Publication
(10) Pub. No.: US 2010/0185498 A1
(43) Pub. Date: Jul. 22, 2010

(54) SYSTEM FOR RELATIVE PERFORMANCE BASED VALUATION OF RESPONSES

(75) Inventor: Michael E. Bechtel, Naperville, IL (US)

Correspondence Address: ACCENTURE CHICAGO 28164;BRINKS HOFER GILSON & LIONE, P O BOX 10395, CHICAGO, IL, 60610, US

(73) Assignee: ACCENTURE GLOBAL SERVICES GMBH, Schaffhausen (CH)

(21) Appl. No.: 12/707,464

(22) Filed: Feb. 17, 2010

Related U.S. Application Data
(63) Continuation-in-part of application No. 12/474,468, filed on May 29, 2009.
Application No. 12/474,468 is a continuation-in-part of application No. 12/036,001, filed on Feb. 22, 2008.

(51) Int. Cl. G06Q 10/00

(52) U.S. Cl. 705/10

(57) ABSTRACT

A system for relative performance based valuation of responses is described. The system may include a memory, an interface, and a processor. The memory may store responses related to an item and scores of the responses. The interface receives the responses and communicates with devices of users. The processor may receive the responses related to the item. The processor may provide, to devices of the users, pairs of the responses. For each pair of responses, the processor may receive, from the devices of the users, a selection of a response. The processor may calculate scores for each response based on the number of times each response was presented to the users for selection, the number of times each response was selected by the users, and an indication of the other responses of the plurality of responses each response was presented with. The processor may store the scores in the memory.

### CROSS-REFERENCE TO RELATED APPLICATIONS

This application is a continuation-in-part of U.S. patent application Ser. No. 12/474,468, filed on May 29, 2009, which is a continuation-in-part of U.S. patent application Ser. No. 12/036,001, filed on Feb. 22, 2008, both of which are incorporated by reference herein.

### TECHNICAL FIELD

The present description relates generally to a system and method, generally referred to as a system, for relative performance based valuation of responses, and more particularly, but not exclusively, to valuating a response based on the performance of the response when presented for selection to users relative to the performance of other responses simultaneously presented for selection to users.

### BACKGROUND

The growth of the Internet has led to a proliferation of products and services available online to users. For example, users can purchase almost any product at online stores, or can rent almost any video through online video rental services. In both examples, the sheer quantity of options available to the users may be overwhelming. In order to navigate the countless options, users may rely on the reviews of other users to assist in their decision making process. The users may gravitate towards the online stores or services which have the most accurate representation of user reviews. Therefore, it may be vital to the business of an online store/service to effectively determine and provide the most accurate user reviews for products/services.

Furthermore, in collaborative environments where users collaborate to enhance and refine ideas, the number of ideas presented to users may increase significantly over time. Users of the collaborative environments may become overwhelmed with ideas to view and rate. Thus, collaborative environments may need to refine the manner in which ideas are presented to users to be rated as the number of ideas presented to the users grows.

### SUMMARY

A system for relative performance based valuation of responses may include a memory, an interface, and a processor. The memory may be connected to the processor and the interface and may store responses related to an item and scores of the responses. The interface may be connected to the memory and may be operative to receive the responses and communicate with devices of the users. The processor may be connected to the interface and the memory and may receive, via the interface, the responses related to the item. The processor may provide, to the devices of the users, pairs of the responses. For each pair of responses, the processor may receive, from the devices of the users, a selection of a response. For example, the selected response may correspond to the response preferred by a user. The processor may calculate the score for each response based on the number of times each response was presented to the users for selection, the number of times each response was selected by the users, and an indication of the other responses of the plurality of responses each response was presented with. The processor may store the scores in the memory.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system relative performance based valuation of responses.

FIG. 2 is a block diagram of a network environment implementing the system of FIG. 1 or other systems for relative performance based valuation of responses.

FIG. 3 is a block diagram of the server-side components in the system of FIG. 2 or other systems for relative performance based valuation of responses.

FIG. 4 is a flowchart illustrating the phases of the systems of FIG. 1, FIG. 2, or FIG. 3, or other systems for relative performance based valuation of responses.

FIG. 5 is a flowchart illustrating the operations of an exemplary phasing processor in the systems of FIG. 1, FIG. 2, or FIG. 3, or other systems for relative performance based valuation of responses.

FIG. 6 is a flowchart illustrating the operations of an exemplary scheduling processor in the systems of FIG. 1, FIG. 2, or FIG. 3, or other systems for relative performance based valuation of responses.

FIG. 7 is a flowchart illustrating the operations of an exemplary rating processor in the systems of FIG. 1, FIG. 2, or FIG. 3, or other systems for relative performance based valuation of responses.

FIG. 8 is a flowchart illustrating the operations of determining response quality scores in the systems of FIG. 1, FIG. 2, or FIG. 3, or other systems for relative performance based valuation of responses.

FIG. 9 is a flowchart illustrating the operations of determining a user response quality score in the systems of FIG. 1, FIG. 2, or FIG. 3, or other systems for relative performance based valuation of responses.

FIG. 10 is a screenshot of a response input interface in the systems of FIG. 1, FIG. 2, or FIG. 3, or other systems for relative performance based valuation of responses.

FIG. 11 is a screenshot of a response selection interface in the systems of FIG. 1, FIG. 2, or FIG. 3, or other systems for relative performance based valuation of responses.

FIG. 12 is an illustration of a response modification interface in the systems of FIG. 1, FIG. 2, or FIG. 3, or other systems for relative performance based valuation of responses.

FIG. 13 is a screenshot of a reporting screen in the systems of FIG. 1, FIG. 2, or FIG. 3, or other systems for relative performance based valuation of responses.

FIG. 14 is an illustration of a general computer system that may be used in the systems of FIG. 2 or FIG. 3, or other systems for relative performance based valuation of responses.

### DETAILED DESCRIPTION

A system and method, generally referred to as a system, may relate to relative performance based valuation of responses, and more particularly, but not exclusively, to valuating a response based on the performance of the response when presented for selection to users relative to the performance of other responses simultaneously presented for selection to users. The principles described herein may be embodied in many different forms.

The system allows an organization to accurately identify the most valuable ideas submitted in a collaborative environment by valuating the ideas with a relative performance based valuation. For example, the system may present the ideas to users for review in a competition based rating format. The competition based rating format simultaneously presents at least two of the submitted ideas to the users and asks the users to select the preferred idea. The system stores the number of times an idea is presented to the users, the number of times the idea is selected, the number of times the idea is not selected, and the other ideas simultaneously presented with the idea. The system may continuously present different permutations of at least two ideas to the users and may receive and store the selections of the users. The system may score the ideas each time new selections are received from the users. An idea may be scored based on how many times the idea was selected by the users and the relative performance of the other ideas simultaneously presented to the users with the idea, as identified by scores of the other ideas. Thus, the value of an idea is not only based on the raw performance of the idea, but on the strength or weakness of the other ideas presented simultaneously with the idea. The system may determine which ideas to present together to the users based on an algorithm incorporating the number of times each idea has been presented to the users and the current ratings of the ideas. For example, the system may attempt to present the ideas to the users an equal number of times. Thus, the algorithm may prioritize presenting ideas which have been presented less frequently. The algorithm may also attempt to simultaneously present ideas with substantially similar scores in order to determine which of the ideas is actually preferred by the users. After a period of time, the system may provide the highest scored ideas to an administrator. Alternatively, or in addition, the system may implement a playoff phase where a new group of ideas is created containing only the highest scored ideas. The new group of ideas is then evaluated through the competition based rating format. The highest scored items from the playoff phase may then be presented to an administrator.

The system may enable users in a collaborative environment to easily access ideas to be rated, enhance ideas, and contribute new ideas. For example, the system may provide users with a user interface for evaluating ideas in the competition based rating format. The interface may present at least two ideas to the users for review. In addition to receiving a selection of the preferred idea from a user, the user interface may allow the user to enhance the presented ideas, or to provide a new idea. The interface may facilitate the users in rating ideas, enhancing ideas, and contributing new ideas. Thus, the system may increase the collaborative activity of the users.

An online retailer or service provider may use the system to identify the most valuable responses provided by users regarding the products or services provided. The online retailer or service provider may wish to prominently display the most valuable responses with the associated products or services. For example, an online retailer may provide users with a user interface for providing reviews and/or ratings of a product being offered for sale. Once the online retailer has collected a number of reviews of the product, the online retailer may implement the competition based rating format to provide the users with an efficient manner of rating user reviews. The online retailer may use data collected from the competition based rating format to generate relative performance valuations of the reviews. The online retailer may then identify the most valuable review and ensure the most valuable review is displayed prominently with the associated product. The system may likewise be used by an online service provider, such as an online video rental service. The video rental service may receive reviews from users of movies rented by the users. The video rental service may allow other users to rate the reviews to identify reviews which are the most helpful, accurate, etc. The video rental service may use the competition based rating format to present the reviews to the users to be rated. The online retailer may generate relative performance valuations of the reviews and may prominently display the highest rated reviews for a given video.

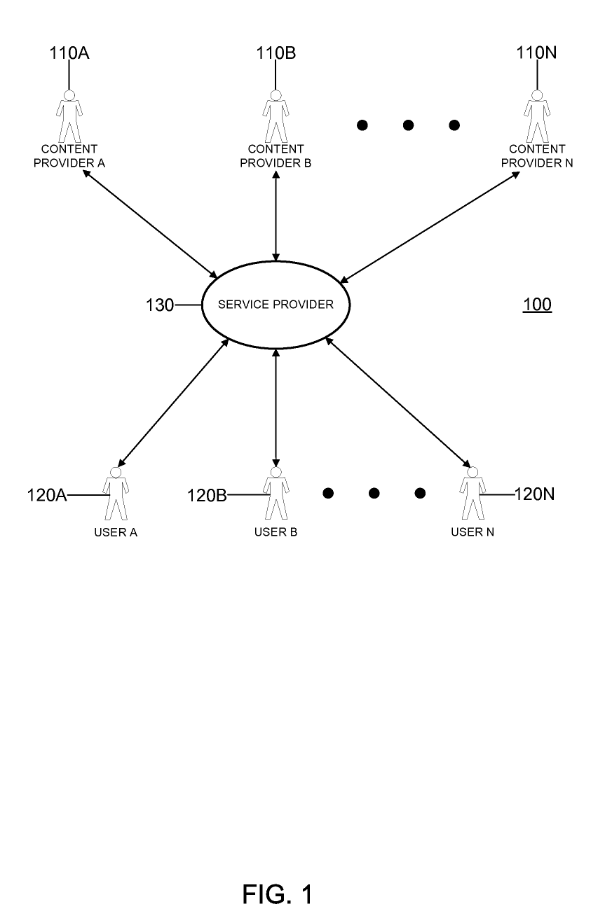

FIG. 1 provides a general overview of a system 100 for relative performance based valuation of responses 100. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more content providers 110A-N, such as any providers of content, products, or services for review, a service provider 130, such as a provider of a collaborative environment, or a provider of a competition based rating system, and one or more users 120A-N, such as any users in a collaborative environment, or generally any users 120A-N with access to the services provided by the service provider 130. For example, in an organization the content providers 110A-N may be upper management, or decision makers within the organization who provided questions to the users 120A-N, while the users 120A-N may be employees of the organization. In another example, the content providers 110A-N may be administrators of an online collaborative web site, such as WIKIPEDIA, and the users 120A-N may be any one providing knowledge to the collaborative website. In another example, the content providers may be online retailers or online service providers who provide access to products, or services, for the users 120A-N to review. Alternatively, or in addition, the users 120A-N may be the content providers 110A-N and vice-versa.

The system 100 may provide an initial item to the users 120A-N to be reviewed and/or rated. The initial item may be any content capable of being responded to by the users 120A-N, such as a statement, a question, a news article, an image, an audio clip, a video clip, a product for rental/sale, or generally any content. In the example of an organization, a content provider A 110A may provide a question as the initial item, such as a question whose answer is of importance to the upper management of the organization. In the example of an online retailer, the online retailer may provide access to products which the users 120A-N may rate and/or review.

One or more of the users 120A-N and/or one or more of the content providers 110A-N may be an administrator of the collaborative environment. An administrator may be generally responsible for maintaining the collaborative environment and may be responsible for maintaining the permissions of the users 120A-N and the content providers 110A-N in the collaborative environment. The administrator may need to approve of any new users 120A-N added to the collaborative environment before the users 120A-N are allowed to provide responses and/or ratings.

The users 120A-N may provide responses to the initial item, such as comments, or reviews, or generally any information that may assist a collaborative process. The users 120A-N may also provide ratings of the responses of the other users 120A-N. The ratings may be indicative of whether the users 120A-N believe the response is accurate, or preferred, for the initial item. For example, if the initial item is a question the users 120A-N may rate the responses based on which response they believe is the most accurate response to the question, or the response which they prefer for the question. The system 100 may initially allow the users 120A-N to rate any of the responses submitted by the users 120A-N. However, over time the number of responses submitted may grow to an extent that the users 120A-N may become overwhelmed with the number of responses to rate. The system 100 may implement a competition based rating format when the number of responses begins to overwhelm the users 120A-N. For example, the system 100 may determine when the users 120A-N are becoming overwhelmed based on the number of items rated by the users over time. If the number of ratings over an interval decreases from an average number of ratings, the system 100 may begin the competition based rating format. Alternatively, the system 100 may implement the competition based rating format from the beginning of the rating process.

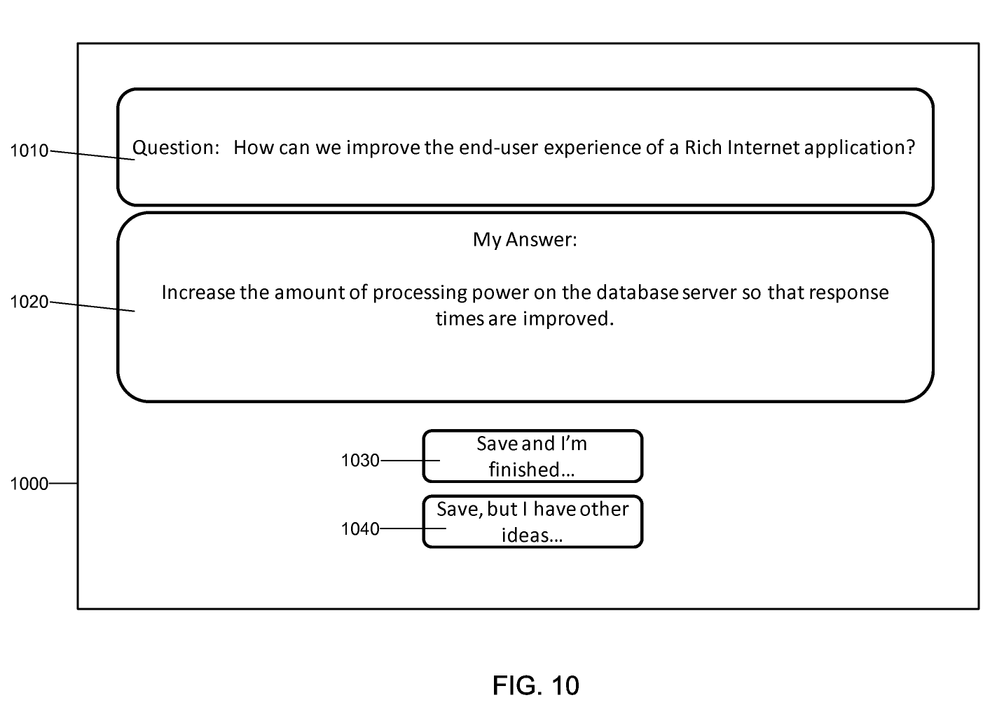

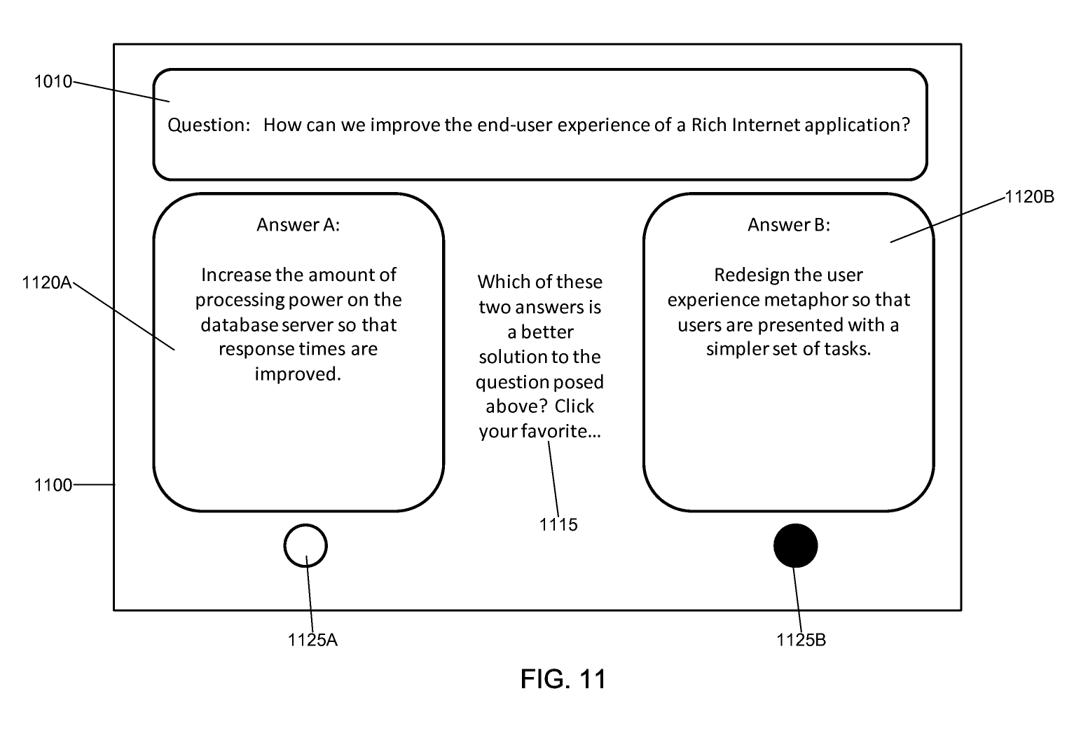

The competition based rating format may have multiple stages, or phases, which determine when the users 120A-N can provide responses and/or rate responses. The first phase may be a write-only phase, where users 120A-N may only submit responses. The system 100 may provide the users 120A-N with an interface for submitting responses, such as the user interface shown in FIG. 10 below. The second phase may be a write and rate phase, where the users 120A-N may rate existing responses in the competition based rating format, write new responses, and/or enhance existing responses. In the write and rate phase, a user A 120A may be provided with a user interface which presents two or more responses to the user A 120A. The user A 120A may use the user interface to select the response which they believe to be the most accurate, or preferred, out of the responses presented. The user A 120A may also use the interface to enhance one of the presented responses, or add a new response. For example, the service provider 130 may provide the users 120A-N with the interface described in FIG. 11 below during the write and rate phase.

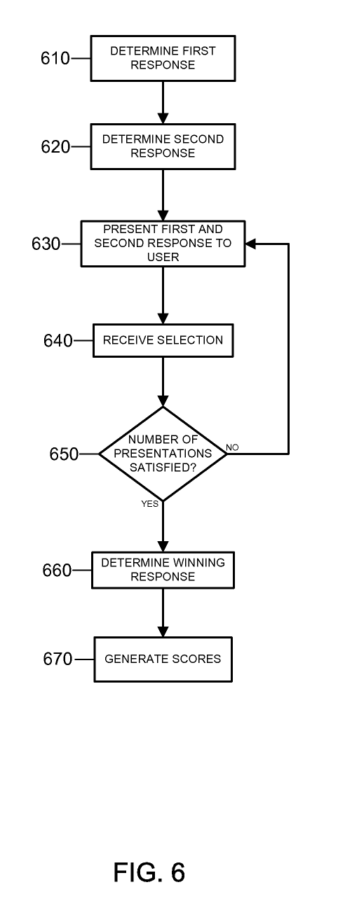

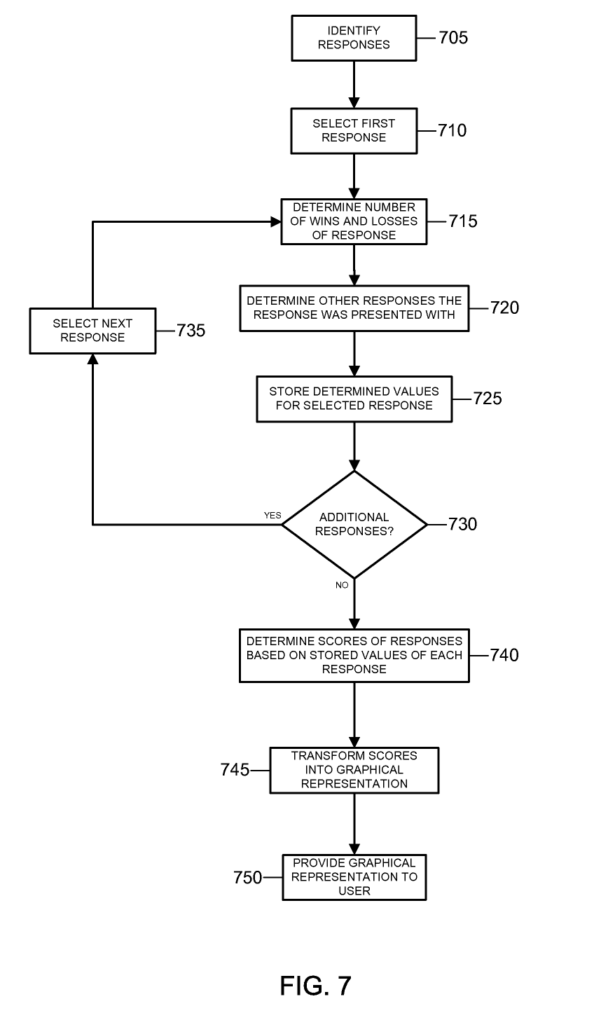

The system 100 may use one or more factors to determine which responses should be presented to the user A 120A, such as the number of times the responses have been viewed, and the current scores of the responses. The steps of determining which responses to provide to the user A 120A are discussed in more detail in FIG. 6 below. The system 100 may continuously calculate the scores of the responses in order to determine which responses to present to the users 120A-N. The scores may be based on the number of times a response was selected when presented to the users, the number of times the response was not selected when presented to the users 120A-N, and the scores of the other responses presented with the response. The steps of calculating the scores of the responses are discussed in more detail in FIG. 7 below.

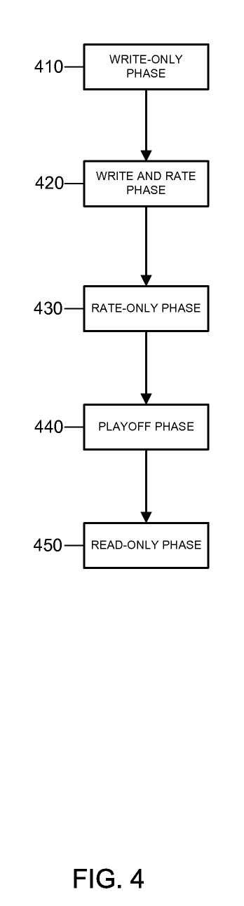

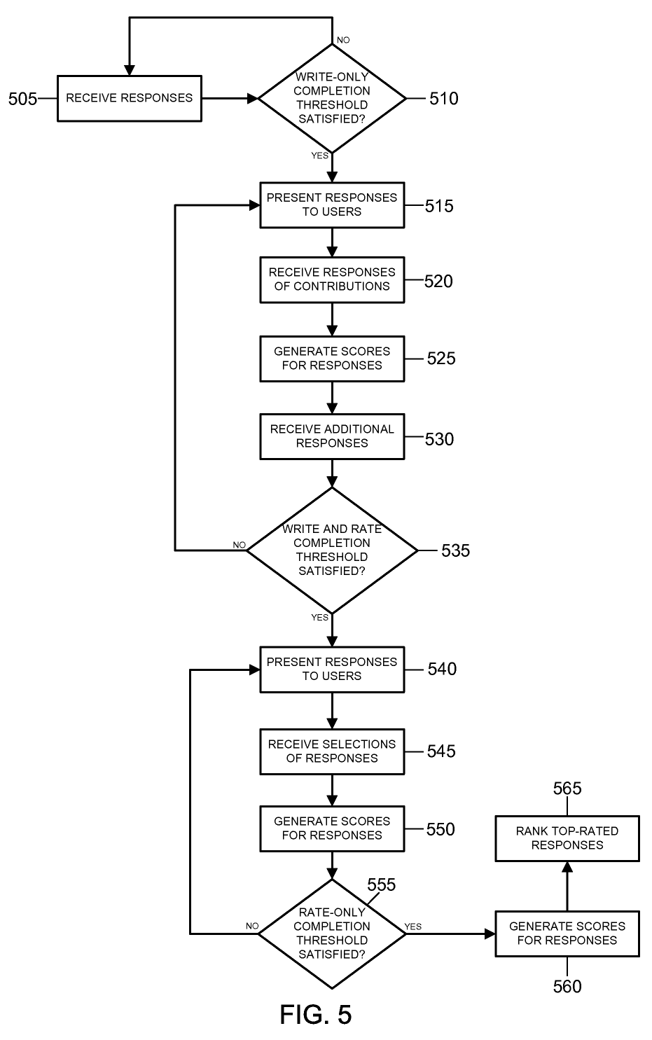

The third phase may be a rate-only phase, where the users 120A-N may be presented with two or more responses and select the response they believe is the most accurate, or preferred. The fourth phase may be a playoff phase where only the highest rated responses are provided to the users 120A-N for rating. The third and/or fourth phase may be optional. The fifth phase may be a read-only, or archiving phase, where the responses, and associated scores, are stored in a data store and/or presented to an administrator, supervisor, or other decision-maker. The phases of the system 100 are discussed in more detail in FIGS. 4-5 below.

In a collaborative environment, the service provider 130 may order the responses based on the scores, and may provide the ordered responses to the content provider A 110A who provided the initial item. The list of responses may be provided to the content provider A 110A in a graphical representation. The graphical representation may assist the content provider A 110A in quickly reviewing the responses with the highest response quality scores and selecting the response which the content provider A 110A believes is the most accurate. The content provider A 110A may provide an indication of their selection of the most accurate response to the service provider 130.

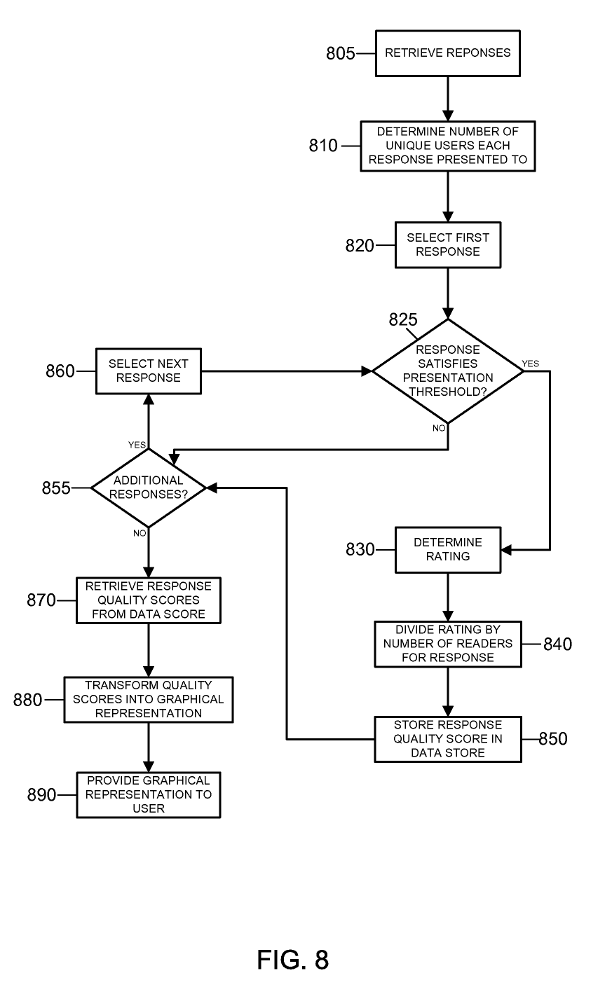

Alternatively or in addition, the service provider 130 may use the score of a response, and the number of users 120A-N who the response was presented to, to generate a response quality score for the response. For example, the response quality score of a response may be determined by dividing the score of the response by the number of unique users 120A-N who the response was presented to. Alternatively, the result may be divided by the number of unique users 120A-N who viewed the response. The service provider 130 may only provide responses to the content provider A 110A if the responses have been presented to enough of the users 120A-N for the response quality scores to be deemed substantial. The service provider 130 may identify a presentation threshold, and may only provide response quality scores for responses which satisfy the presentation threshold. For example, the service provider 130 may only provide response quality scores for the responses which are in the upper two-thirds of the responses in terms of total presentations to the users 120A-N. In this example, if there are three responses, two which were presented to ten users 120A-N, and one which was only presented to eight users 120A-N, the service provider 130 may only generate a response quality score for the responses which were presented to ten users 120A-N. By omitting response quality scores for responses with a small number of presentations, the service provider 130 can control for sampling error which may be associated with a relatively small sample set. The steps of determining response quality scores are discussed in more detail in FIG. 8 below.

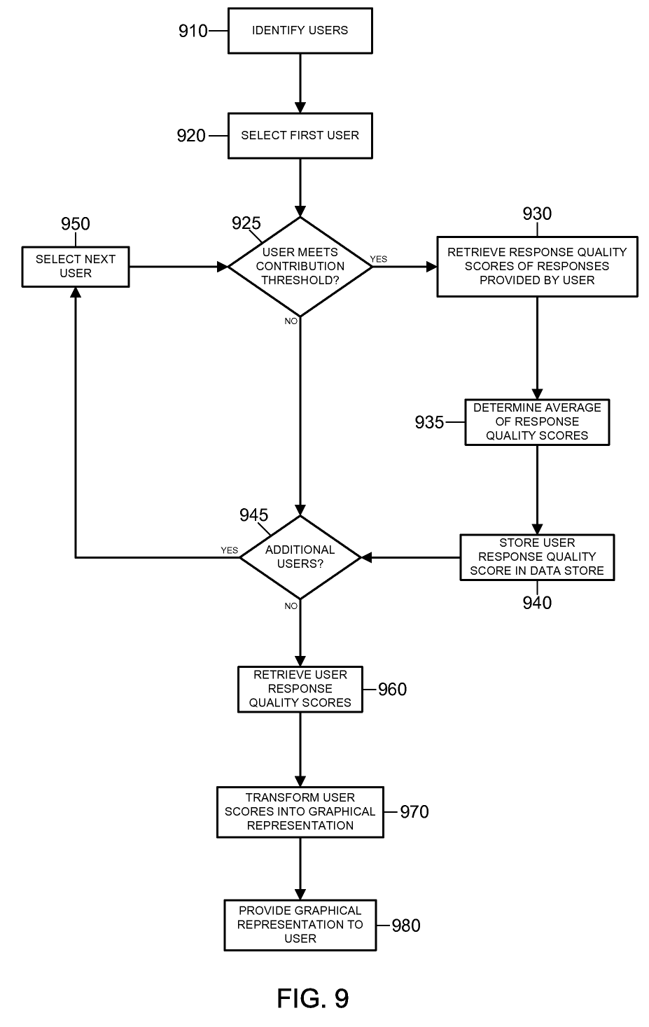

The service provider 130 may maintain a user response quality score for each of the users 120A-N in the collaborative environment. The user response quality score may be indicative of the level of proficiency of the users 120A-N in the collaborative environment. The user response quality score of a user A 120A may be based on the scores, or response quality scores, of the responses provided by the user A 120A. For example, the user response quality score of a user A 120A may be the average of the scores, or response quality scores, of the responses provided by the user A 120A. The service provider 130 may only determine user response quality scores of a user A 120A if the number of responses provided by the user A 120A meets a contribution threshold. For example, the service provider 130 may only determine the user response quality score for the users 120A-N who are in the upper two-thirds of the users 120A-N in terms of total responses contributed to the collaborative environment. In this example, if a user A 120A contributed ten responses, a user B 120B contributed ten responses, and a user N 120N contributed eight responses, then the service provider 130 may only determine a user response quality score of the user A 120A and the user B 120B. By excluding the users 120A-N with low numbers of contributions, the service provider 130 can control sampling error which may be associated with a relatively small number of contributions. The steps of determining user response quality scores of the users 120A-N in this manner are discussed in more detail in FIG. 9 below.

Alternatively or in addition, the user response quality score for the user A 120A may be based on the number of responses the user A 120A has contributed to the collaborative environment, the number of times the responses of the user A 120A have been viewed by the other users 120B-N, the average score of the responses of the user A 120A, and the number of responses of the user A 120A which have been selected as the most accurate response by one of the content providers 110A-N. The user response quality score may be normalized across all of the users 120A-N. For example, if the user response quality score is based on the number of responses provided by the user A 120A, the service provider 130 may divide the number of responses provided by the user A 120A by the average number of responses provided by each of the users 120A-N to determine the user response quality score of the user A 120A.

Alternatively, or in addition, the service provider 130 may use the user response quality score as a weight in determining the total ratings of the responses by multiplying the user response quality score by each rating provided by the user A 120A. In the case of the competition based format, the service provider 130 may rate each selection of the user. Thus, when the user selects an item in the competition based weighting format, the value of the selection is weighted based on the normalized user response quality score of the user. By multiplying the value applied to the selections of the users 120A-N by a normalized weight, the selections of the more proficient users 120A-N may be granted a greater affect than those of the less proficient users 120A-N.

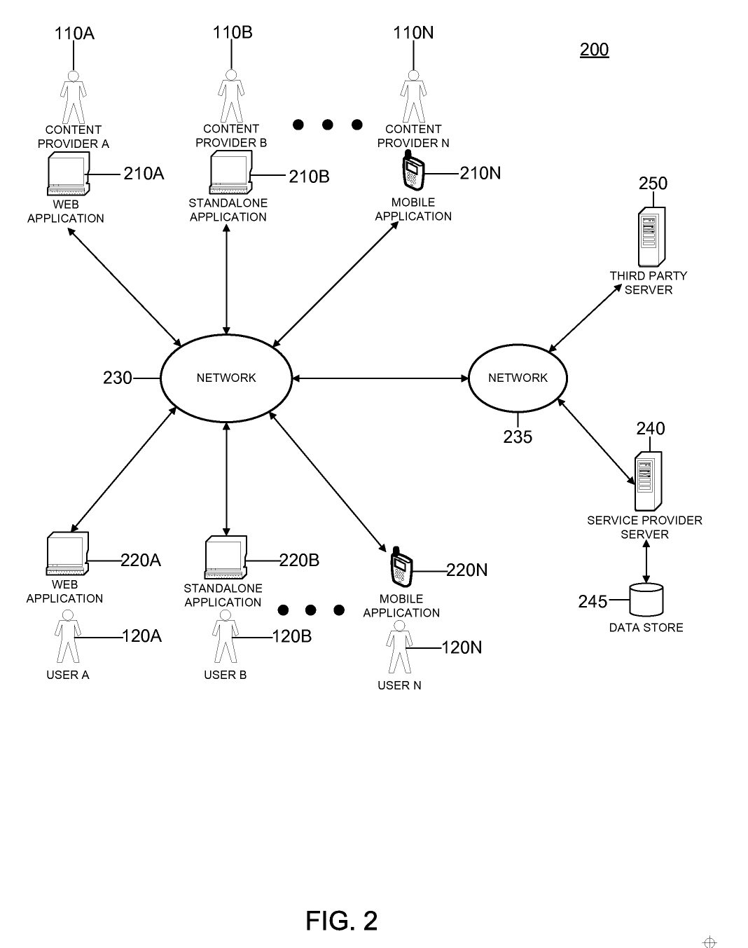

FIG. 2 provides a view of a network environment 200 implementing the system of FIG. 1 or other systems for relative performance based valuation of responses. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more web applications, standalone applications and mobile applications 210A-N, which may be client applications of the content providers 110A-N. The network environment 200 may also include one or more web applications, standalone applications, mobile applications 220A-N, which may be client applications of the users 120A-N. The web applications, standalone applications and mobile applications 210A-N, 220A-N, may collectively be referred to as client applications 210A-N, 220A-N. The network environment 200 may also include a network 230, a network 235, the service provider server 240, a data store 245, and a third party server 250.

Some or all of the service provider server 240 and third-party server 250 may be in communication with each other by way of network 235. The third-party server 250 and service provider server 240 may each represent multiple linked computing devices. Multiple distinct third party servers, such as the third-party server 250, may be included in the network environment 200. A portion or all of the third-party server 250 may be a part of the service provider server 240.

The data store 245 may be operative to store data, such as user information, initial items, responses from the users 120A-N, ratings by the users 120A-N, selections by the users, scores of responses, response quality scores, user response quality scores, user values, or generally any data that may need to be stored in a data store 245. The data store 245 may include one or more relational databases or other data stores that may be managed using various known database management techniques, such as SQL and object-based techniques. Alternatively or in addition the data store 245 may be implemented using one or more of the magnetic, optical, solid state or tape drives. The data store 245 may be in direct communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet.

The content providers 110A-N may use a web application 210A, standalone application 210B, or a mobile application 210N, or any combination thereof, to communicate to the service provider server 240, such as via the networks 230, 235. Similarly, the users 120A-N may use a web application 220A, a standalone application 220B, or a mobile application 220N to communicate to the service provider server 240, via the networks 230, 235.

The service provider server 240 may provide user interfaces to the content providers 110A-N via the networks 230, 235. The user interfaces of the content providers 110A-N may be accessible through the web applications, standalone applications or mobile applications 210A-N. The service provider server 240 may also provide user interfaces to the users 120A-N via the networks 230, 235. The user interfaces of the users 120A-N may also be accessible through the web applications, standalone applications or mobile applications 220A-N. The user interfaces may be designed using any Rich Internet Application Interface technologies, such as ADOBE FLEX, Microsoft Silverlight, asynchronous JavaScript or XML (AJAX). The user interfaces may be initially downloaded when the applications 210A-N, 220A-N first communicate with the service provider server 240. The client applications 210A-N, 220A-N may download all of the code necessary to implement the user interfaces, but none of the actual data. The data may be downloaded from the service provider server 240 as needed. The user interfaces may be developed using the singleton development pattern, utilizing the model locator found within the cairngorm framework. Within the singleton pattern there may be several data structures each with a corresponding data access object. The data structures may be structured to receive the information from the service provider server 240.

The user interfaces of the content providers 110A-N may be operative to allow a content provider A 110A to provide an initial item, and allow the content provider A 110A to specify a period of time for review of the item. The user interfaces of the users 120A-N may be operative to display the initial item to the users 120A-N, allow the users 120A-N to provide responses and ratings, and display the responses and ratings to the other users 120A-N. The user interfaces of the content providers 110A-N may be further operative to display the ordered list of responses to the content provider A 110A and allow the content provider to provide an indication of the selected response.

The web applications, standalone applications and mobile applications 210A-N, 220A-N may be connected to the network 230 in any configuration that supports data transfer. This may include a data connection to the network 230 that may be wired or wireless. The web applications 210A, 220A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B, 220B may run on a machine that may have a processor, memory, a display, a user interface and a communication interface. The processor may be operatively connected to the memory, display and the interfaces and may perform tasks at the request of the standalone applications 210B, 220B or the underlying operating system. The memory may be capable of storing data. The display may be operatively connected to the memory and the processor and may be capable of displaying information to the content provider B 110B or the user B 120B. The user interface may be operatively connected to the memory, the processor, and the display and may be capable of interacting with a user B 120B or a content provider B 110B. The communication interface may be operatively connected to the memory, and the processor, and may be capable of communicating through the networks 230, 235 with the service provider server 240, and the third party server 250. The standalone applications 210B, 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX, and PHP, amongst others.

The mobile applications 210N, 220N may run on any mobile device that may have a data connection. The data connection may be a cellular connection, a wireless data connection, an internet connection, an infra-red connection, a Bluetooth connection, or any other connection capable of transmitting data.

The service provider server 240 may include one or more of the following: an application server, a data store, such as the data store 245, a database server, and a middleware server. The application server may be a dynamic HTML server, such as using ASP, JSP, PHP, or other technologies. The service provider server 240 may co-exist on one machine or may be running in a distributed configuration on one or more machines. The service provider server 240 may collectively be referred to as the server. The service provider server 240 may implement a server side wiki engine, such as ATLASSIAN CONFLUENCE. The service provider server 240 may receive requests from the users 120A-N and the content providers 110A-N and may provide data to the users 120A-N and the content providers 110A-N based on their requests. The service provider server 240 may communicate with the client applications 210A-N, 220A-N using extensible markup language (XML) messages.

The third party server 250 may include one or more of the following: an application server, a data source, such as a database server, and a middleware server. The third party server may implement any third party application that may be used in a system relative performance based valuation of responses, such as a user verification system. The third party server 250 may co-exist on one machine or may be running in a distributed configuration on one or more machines. The third party server 250 may receive requests from the users 120A-N and the content providers 110A-N and may provide data to the users 120A-N and the content providers 110A-N based on their requests.

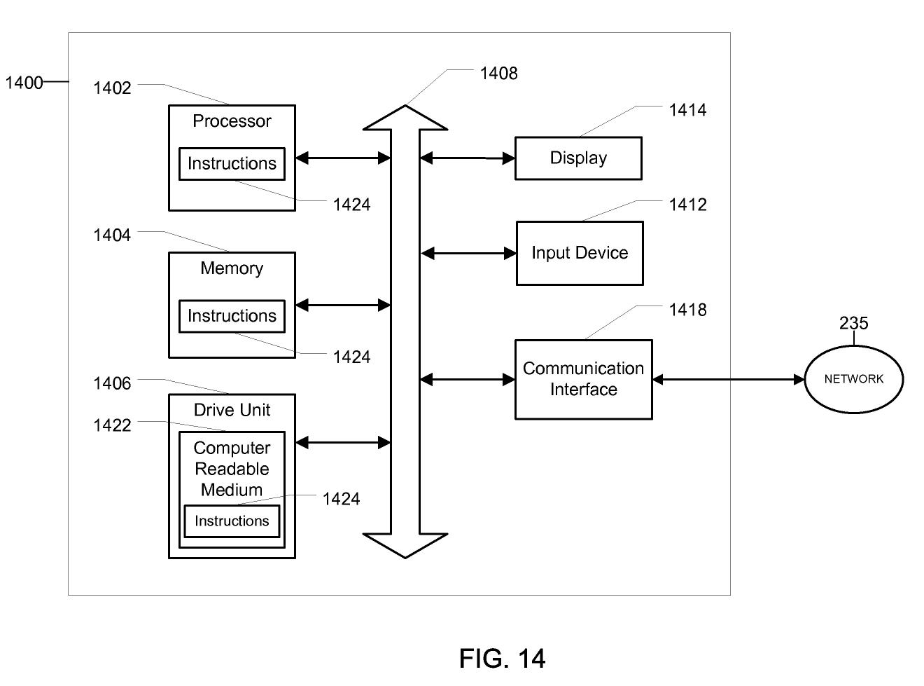

The service provider server 240 and the third party server 250 may be one or more computing devices of various kinds, such as the computing device in FIG. 14. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web applications 210A, 210A may employ HTTP to request information, such as a web page, from a web server, which may be a process executing on the service provider server 240 or the third-party server 250.

There may be several configurations of database servers, such as the data store 245, application servers, and middleware servers included in the service provider server 240, or the third party server 250. Database servers may include MICROSOFT SQL SERVER®, ORACLE®, IBM DB2® or any other database software, relational or otherwise. The application server may be APACHE TOMCAT®, MICROSOFT HS®, ADOBE COLDFUSION®, or any other application server that supports communication protocols. The middleware server may be any middleware that connects software components or applications.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

In operation the client applications 210A-N, 220A-N may make requests back to the service provider server 240. The service provider server 240 may access the data store 245 and retrieve information in accordance with the request. The information may be formatted as XML and communicated to the client applications 210A-N, 220A-N. The client applications 210A-N, 220A-N may display the XML appropriately to the users 120A-N, and/or the content providers 110A-N.

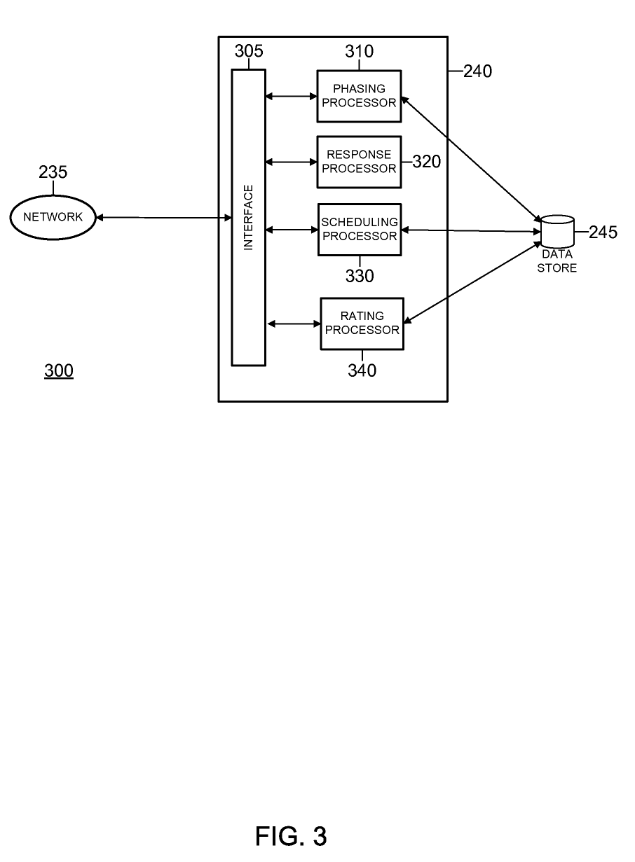

FIG. 3 provides a view of the server-side components in a network environment 300 implementing the system of FIG. 2 or other systems for relative performance based valuation of responses. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 300 may include the network 235, the service provider server 240, and the data store 245. The server provider server 240 may include an interface 305, a phasing processor 310, a response processor 320, a scheduling processor 330 and a rating processor 340. The interface 305, phasing processor 310, response processor 320, scheduling processor 330 and rating processor 340, may be hardware components of the service provider server 240, such as dedicated processors or dedicated processing cores, or may be separate computing devices, such as the one described in FIG. 14.

The interface 305 may communicate with the users 120A-N and the content providers 110A-N via the networks 230, 235. For example, the interface 305 may communicate a graphical user interface displaying the competition based rating format to the users 120A-N and may receive selections of the users 120A-N. The phasing processor 310 may maintain and control the phases of the system 100. The phases of the system 100 may determine when the users 120A-N may submit new responses, enhance responses, rate responses and/or any combination thereof. The phasing processor 310 is discussed in more detail in FIGS. 4-5 below. The response processor 320 may process responses and initial items from the users 120A-N and the content providers 110A-N. The response processor 320 may receive the initial items and responses and may store the initial items and responses in the data store 245. The scheduling processor 330 may control which responses are grouped together and presented to the users 120A-N. The scheduling processor 330 may present responses to the users 120A-N such that each of the responses is presented to the users 120A-N approximately the same number of times. The scheduling processor 330 may also present responses to the users 120A-N such that responses presented in the same group have substantially similar scores. The scheduling processor 330 is discussed in more detail in FIG. 6 below.

The rating processor 340 may receive selections of responses of a group of response from the users 120A-N. The rating processor 340 may store an indication of the selected responses, along with the responses presented in the same group as the selected responses, in the data store 245. The rating processor 340 may calculate a score for each of the responses based on the information stored in the data store 245. The score of the responses may be based on the number of times each response was presented to the users 120A-N, the number of times each response was selected by one of the users 120A-N, and the responses which were presented with the response to the users 120A-N. The steps of calculating the scores of the responses are discussed in more detail in FIG. 7 below.

In operation the interface 305 may receive data from the content providers 110A-N or the users 120A-N via the network 235. For example, one of the content providers 110A-N, such as the content provider A 110A, may provide an initial item, and one of the users 120A-N, such as the user A 120A may provide a response or a rating of a response. In the case of an initial item received from the content provider A 110A, the interface 305 may communicate the initial item to the response processor 320. The response processor 320 may store the initial item in the data store 245. The response processor 320 may store data describing the content provider A 110A who provided the initial item and the date/time the initial item was provided. The response processor 320 may also store the review period identified by the content provider A 110A for the item.

In the case of a response received from the user A 120A, the interface 305 may communicate the response to the response processor 320. The response processor 320 may store the response in the data store 245 along with the initial item the response was based on. The response processor 320 may store user data describing the user A 120A who provided the response and the date/time the response was provided. In the case of a selection of a response received from the user A 120A, the interface 305 may communicate the selection to the rating processor 340. The rating processor 340 may store the selection in the data store 245, along with an indication of the other responses presented with the selected response. The rating processor 340 may also store user data describing the user A 120A who provided the rating, user data describing the user B 120B who provided the response that was rated, and the date/time the response was rated.

The rating processor 340 may determine the score of responses to an initial item, and may order the responses based on their scores. The rating processor 340 may follow the steps of FIG. 7 to determine the scores of the responses. Once the rating processor 340 has calculated the scores of each response, the rating processor 340 may order the responses based on the scores and may provide the ordered responses, along with the scores, to the content provider A 110A who provided the initial item.

The service provider server 240 may re-calculate the scores of the responses each time the data underlying the scores changes, such as each time a response is presented to one of the users 120A-N and selected by one of the users 120A-N. Alternatively, or in addition, the service provider server 240 may calculate the scores on a periodic basis, such as every hour, every day, every week, etc.

FIG. 4 is a flowchart illustrating the phases of the systems of FIG. 1, FIG. 2, or FIG. 3, or other systems for relative performance based valuation of responses. The steps of FIG. 4 are described as being performed by the service provider server 240. However, the steps may be performed by a processor of the service provider server 240, a processing core of the service provider server 240, any other hardware component of the service provider server 240, or any combination thereof. Alternatively the steps may be performed by an external hardware component or device, or any combination thereof.

At step 410, the system 100 begins the write-only phase. The write-only phase may be a period of time during which the users 120A-N may only submit responses, or ideas, to the service provider server 240. The service provider server 240 may not present responses to the users 120A-N in the competition based rating format during the write-only phase. For example, an online retailer may accept reviews from users 120A-N regarding products and/or services offered for sale. The write-only phase may only be necessary if no responses currently exist in the system 100. The write-only phase may continue until a write-only completion threshold is satisfied. The write-only phase completion threshold may be satisfied by one or more events, such as after a number of responses are received, after a duration of time expires, or when one of the users 120A-N, such as an administrator, indicates the end of the write-only phase. For example, the write-only phase may end when at least two responses are submitted by the users 120A-N.

At step 420, the system 100 begins the write and rate phase. The write and rate phase may be a period of time during which the users 120A-N may both submit responses and select preferred responses in the competition based rating format. During the write and rate phase, the service provider server 240 may provide a user interface to the users 120A-N displaying at least two responses in the competition based rating format. The scheduling processor 330 may determine the two or more responses to present to the users 120A-N. The scheduling processor 330 may rotate through the responses such that the responses are presented to the users 120A-N approximately the same number of times. The scheduling processor 330 may also present responses with similar scores to the users 120A-N simultaneously in order to further distinguish responses with similar scores. The users 120A-N may select the response that is the most preferred, accurate, helpful, valuable, or any combination, or derivation, thereof. After selecting one of the responses, the users 120A-N may modify, or enhance, one or more of the presented responses. The scheduling processor 330 may present the same grouping, or pair, of responses to the users multiple times to ensure a sufficient number of user selections are obtained for a given grouping, or pair, of responses. The modified or enhanced responses may be stored in the data store 245. The write and rate phase may continue until a write and rate completion threshold is satisfied. The write and rate phase completion threshold may be satisfied by one or more events, such as after a number of responses are received, after a number of selections of responses are received, after a duration of time expires, or when one of the users 120A-N, such as an administrator, indicates the end of the write-only phase.

At step 430, the system 100 may begin the rate-only phase. During the rate-only phase the users 120A-N may only be able to select one of the presented responses; the users 120A-N may not be able to enhance existing responses, or submit new responses. The rate-only phase may continue until a rate-only completion threshold is satisfied. The rate-only completion threshold may be satisfied by one or more events, such as after a number of ratings are collected, after a duration of time expires, or when one of the users 120A-N, such as an administrator, indicates the end of the write-only phase. Alternatively or in addition, the system 100 may be configured such that the rate-only phase is inactive and therefore may be skipped altogether.

At step 440, the system 100 may begin the playoff phase. The service provider server 240 may select the currently highest scoring responses, such as the top ten highest scoring responses, or the top ten percent of the responses, for participation in the playoff phase. The playoff phase may operate in one of many configurations, with the final result being the response most often selected by the users 120A-N. For example, the responses may be seeded in a tournament. The seeding to the tournament may be based on the current scores of the responses. The responses may be presented to the users 120A-N as they are paired in the tournament. The response which is selected most frequently by the users 120A-N for a given pairing may proceed to the next round of the tournament. The tournament may continue until there is only one response remaining.

Alternatively, or in addition, the scores of the responses may be reset and the competition based rating process may be repeated with only the highest scoring responses. Thus, during the playoff phase the users 120A-N will always be presented with at least two high scoring responses to select from. The system 100 may restart at the rate-only phase and may continue the rate only phase until the rate-only completion threshold is satisfied. The response with the highest score at the end of the rate only phase may be deemed the most accurate response.

At step 450, the system 100 begins the read-only phase, or reporting phase. During the read-only phase, the service provider server 240 transforms the responses and scores into a graphical representation. The graphical representation of the responses and scores are provided to the administrator, supervisor, or decision maker. In the example of an online retailer, the responses may be displayed in order of their scores, such that the users 120A-N viewing the product can read the most pertinent reviews first. Alternatively or in addition, the highest scoring response may be displayed prominently with the product being sold, such that the users 120A-N can quickly identified the highest scoring response.

FIG. 5 is a flowchart illustrating the operations of an exemplary phasing processor in the systems of FIG. 1, FIG. 2, or FIG. 3, or other systems for relative performance based valuation of responses. The steps of FIG. 5 are described as being performed by the service provider server 240. However, the steps may be performed by a processor of the service provider server 240, a processing core of the service provider server 240, any other hardware component of the service provider server 240, or any combination thereof. Alternatively the steps may be performed by an external hardware component or device, or any combination thereof.

At step 505, the service provider server 240 may receive responses from the users 120A-N, such as responses to an item provided for review, reviews of products and/or services, or generally any user commentary relating to a theme, topic, idea, question, product, service, or combination thereof. At step 510, the service provider server 240 may determine whether the write-only completion threshold has been satisfied. As previously mentioned, the write-only completion threshold may be satisfied by one or more events, such as after a number of responses are received, after a duration of time expires, or when one of the users 120A-N, such as an administrator, indicates the end of the write-only phase. If, at step 510, the write-only completion threshold is not satisfied, the service provider server 240 returns to step 505 and continues to receive responses.

If, at step 510, the service provider server 240 determines that the write-only completion threshold has been satisfied, the service provider server 240 moves to step 515. At step 515, the service provider server 240 may begin the write and rate phase by presenting two or more responses for selection by the users 120A-N. For example, the service provider server 240 may present two responses to the user A 120A, such as through the user interface described in FIG. 11 below. The service provider server 240 may select the two or more responses to present to the user A 120A such that the responses are presented to the users 120A-N a substantially similar number of times and such that responses having similar scores are presented together.

At step 520, the service provider server 240 may receive selections of responses from the users 120A-N. For example, the users 120A-N may use a user interface provided by the service provider server 240, such as the user interface shown in FIG. 11 below, to select one of the responses presented to the users 120A-N in the competition based rating format. For each selection received, the service provider server 240 may store an indication in the data store 245 that the selected response was preferred over the unselected responses. Alternatively or in addition, the service provider server 240 may present the same set of responses to multiple users 120A-N. The service provider server 240 may not store an indication that one of the responses was preferred over the others until one of the responses is selected a specified number of times. For example, if the specified number of times is fifteen times, the service provider server 240 may continue to display the set of responses to users 120A-N until one of the responses is selected fifteen times. Once one of the responses is selected fifteen times, the service provider server 240 stores an indication that the response was preferred over the other response.

At step 525, the service provider server 240 may generate scores for the responses each time one of the responses is selected by the users 120A-N. Alternatively or in addition, the service provider server 240 may generate the scores at periodic time intervals, or as indicated by one of the users 120A-N, such as an administrator. The steps of calculating the scores are discussed in more detail in FIG. 7 below. At step 530, the service provider server 240 may continue to receive new responses, or enhancements of existing responses. At step 535, the service provider server 240 determines whether the write and rate completion threshold is satisfied. As mentioned above, the write and rate completion threshold may be satisfied by one or more events, such as after a number of responses are received, after a number of selections of responses are received, after a duration of time expires, or when one of the users 120A-N, such as an administrator, indicates the end of the write-only phase. If, at step 535, the service provider server 240 determines that the write and rate threshold is not satisfied, the service provider server 240 returns to step 515 and continues to receive responses and selections of responses from the users 120A-N.

If, at step 535, the service provider server 240 determines that the write and rate completion threshold is satisfied, the service provider server 240 moves to step 540. At step 540, the service provider server 240 begins the rate-only phase. During the rate-only phase, the service provider server 240 may continue to present responses for selection by the users 120A-N. At step 550, the service provider server 240 continues to generate scores for the responses, as discussed in more detail in FIG. 7 below. At step 555, the service provider server 240 determines whether the rate-only completion threshold is satisfied. The rate-only completion threshold may be satisfied by one or more events, after a number of selections of responses are received, after a duration of time expires, or when one of the users 120A-N, such as an administrator, indicates the end of the write-only phase. Alternatively or in addition, the system 100 may be configured such that the rate-only phase is inactive and therefore may be skipped altogether. If at, step 555, the service provider server 240 determines that the rate-only threshold is not satisfied, the service provider server 240 returns to step 540 and continues presenting responses to the users 120A-N and receiving selections of responses from the users 120A-N.

If, at step 555, the service provider server 240 determines that the rate-only period completion threshold is satisfied, the service provider server 240 moves to step 560. At step 560, the service provider server 240 may generate the final scores for the responses. Alternatively, or in addition, as mentioned above, the service provider server 240 may enter a playoff phase with the responses to further refine the scores of the responses. At step 565, the service provider server 240 ranks the highest scored responses. The highest scored responses may be provided to the content provider A 110A who provided the item to be reviewed, such as an online retailer, service provider, etc. For example, in an online collaborative environment, the ranked responses may be provided to the decision-maker responsible for the initial item. Alternatively, or in addition, an online retailer may provide the ordered responses to users 120A-N along with the associated product the responses relate to.

FIG. 6 is a flowchart illustrating the operations of an exemplary scheduling processor in the systems of FIG. 1, FIG. 2, or FIG. 3, or other systems for relative performance based valuation of responses. The steps of FIG. 6 are described as being performed by the scheduling processor 330 or the service provider server 240. However, the steps may be performed by a processor of the service provider server 240, a processing core of the service provider server 240, any other hardware component of the service provider server 240, or any combination thereof. Alternatively the steps may be performed by an external hardware component or device, or any combination thereof.

At step 610, the scheduling processor 330 determines a first response to present to one of the users 120A-N, such as the user A 120A. The scheduling processor 330 may select the response which has been presented the least number of times, collectively, to the users 120A-N. Alternatively, or in addition, the scheduling processor 330 may select the response which has been presented the least number of times, collectively, to the users 120A-N, and, as a secondary factor, the response which has been presented the least number of times, individually, to the user A 120A. At step 620, the scheduling processor 330 determines a second response to present to the user A 120A, along with the first response. For example, the scheduling processor 330 may select the response which has not previously been presented with the first response and has a score substantially similar to the score of the first response. If multiple responses have substantially similar scores as the first response, and have not been presented with the first response, the scheduling processor 330 may select the response which has been presented the least number of times, collectively, to the users 120A-N and/or the least number of times, individually, to the user A 120A.

At step 630, the service provider server 240 presents the first and second responses to the user A 120A. For example, the service provider server 240 may utilize the user interface shown in FIG. 11 below to present the first and second responses to the user A 120A. At step 640, the service provider server 240 receives a selection of the first or second response from the user A 120A. For example, the user A 120A may use the interface in FIG. 11 below to select one of the presented responses. At step 650, the service provider server 240 may determine whether the number of presentations of the responses has been satisfied. In order to produce more reliable results, the service provider server 240 may present the pairs of response together a number of times, before determining that one of the responses is preferred by the users 120A-N over the other response. For example, the service provider server 240 may repeatedly present the pairing of the first response and the second response to the users 120A-N until one of the responses is selected a number of times, such as fifteen times, or until the responses have been presented together a number of times, such as fifteen times. If, at step 650, the service provider server 240 determines that the number of presentations of the responses has not been satisfied, the service provider server 240 returns to step 630 and continues to present the pair of responses to the users 120A-N.

If, at step 650, the service provider server 240 determines that the number of presentations is satisfied, the service provider server 240 moves to step 660. At step 660, the service provider server 240 determines the response preferred by the users 120A-N by determining which response was selected more often. The service provider server 240 may store an indication of the response which was preferred, the response which was not preferred, and the number of times the responses were selected when presented together. At step 670, the service provider server 240 may generate scores for all of the responses which includes the new data derived from the presentation of the first and second response. The steps of calculating the scores are discussed in more detail in FIG. 7 below.

FIG. 7 is a flowchart illustrating the operations of an exemplary rating processor in the systems of FIG. 1, FIG. 2, or FIG. 3, or other systems for relative performance based valuation of responses. The steps of FIG. 7 are described as being performed by the rating processor 340 and/or the service provider server 240. However, the steps may be performed by a processor of the service provider server 240, a processing core of the service provider server 240, any other hardware component of the service provider server 240, or any combination thereof. Alternatively the steps may be performed by an external hardware component or device, or any combination thereof.

At step 705, the rating processor 340 identifies all of the responses which were submitted in the system 100 and presented to the users 120A-N. At step 710, the rating processor 340 selects a first response. At step 715, the rating processor 340 determines the number of times the first response was determined to be the preferred response when presented to the users 120A-N, and the number of times the first response was determined to not be the preferred response when presented to the users 120A-N. In this exemplary score determination, the rating processor 340 counts the number of times the response was determined to be preferred, or not preferred, over other responses as determined in step 660 in FIG. 6, not the raw number of times the response was selected by the users 120A-N. Thus, if the service provider server 240 presents a pair of responses to users 120A-N until one of the responses is selected fifteen times, the rating processor 340 counts the response which is determined to be the preferred response once, not fifteen times. Essentially, the rating processor 340 ignores the margin of victory of the preferred response over the non-preferred response. Alternatively, the rating processor 340 may implement another scoring algorithm which incorporates the margin of victory between the responses.

At step 720, the rating processor 340 determines the other responses the first response was presented with to the users 120A-N and the number of times the other responses were presented with the first response, regardless of whether the response was ultimately determined to be the preferred response. At step 725, the rating processor 340 stores the number of times the response was preferred, the number of times the response was not preferred, an identification of each of the other responses the response was presented with, and the number of times each of the other responses were presented with the response. At step 730, the rating processor 340 determines whether there are any additional responses not yet evaluated. If, at step 730, the rating processor 340 determines there are additional responses which have not yet been evaluated, the rating processor 340 moves to step 735. At step 735, the rating processor 340 selects the next response to be evaluated and returns to step 715. The rating processor 340 may repeat steps 715-730 for each of the additional responses.

If, at step 730, the rating processor 340 determines there are no additional responses to be evaluated, the rating processor 340 moves to step 740. At step 740, the rating processor 340 determines the scores of all of the responses, based on the number of times each response was preferred, the number of times each response was not preferred, and the number of times the other responses were presented with each response. The scores of the responses may be calculated using a system of linear equations where the number of times each of the responses was presented, the number of times each of the responses was selected, and the number of times the other responses were presented with each of the responses are values used in the system of linear equations.

For example, the rating processor 340 may use a matrix, such as a matrix substantially similar to the Colley Matrix, to determine the scores through the system of linear equations. The Colley Matrix Method is described in more detailed in “Colley's bias free college football ranking method: the Colley matrix explained,” which can be found at http://www.colleyrankings.com/#method.

In the Colley Matrix Method, an initial score for each response is calculated as:

$$score = \frac{1 + {n}_{s}}{2 + {n}_{tot}} ,$$

where nₛ represents the number of times the response was selected and nₜₒₜ represents the total number of times the response was presented. Thus, before any of the responses are presented to the users, the number of times any response has been selected (nₛ) or presented (nₜₒₜ) is 0. Thus, initially the score of each of the responses can be calculated as:

$$score = \frac{1 + 0}{2 + 0} ,$$

which equals approximately ½, or 0.5. Once responses have been presented to the users, and have been selected by the users, the system 100 can incorporate the number of times the responses were presented and selected into the calculation.

The system 100 can also incorporate the scores of the other responses presented to the users with a given response. Thus, the system 100 can incorporate a strength of a selection of a response based on the score of the response it was presented with. For example, the system 100 may use the following equation to determine scores for all of the responses:

$$( 2 + {n}_{tot , i} ) {score}_{i} - {\sum }_{j = 1}^{{n}_{tot , i}} {score}_{j}^{i} = 1 + \frac{{n}_{s , i} - {n}_{ns , i}}{2} ,$$

where n_{tot,i} represents the total number of times the i^{th} response was presented to the users 120A-N, the scoreᵢ represents the current score of the i^{th} response, the scoreⁱⱼ represents the score of the j^{th} response which was presented with the i^{th} response, the n_{s,i} represents the number of times the i^{th} response was selected by the users, and the n_{ns,i} represents the number of times the i^{th} response was not selected by the users. The equation can be rewritten in matrix form as C\vec{s}=\vec{b}, where \vec{s} is a column vector of all the scores scoreᵢ, and \vec{b} is a column vector of the right-hand side of the equation. In the matrix C, the i^{th} row has as its i^{th} entry 2+n_{tot,i} and an entry of −1 for each response j which was presented with the response. Alternatively, if the responses are presented together multiple times, the entry for each response j which was presented with the response may be a negative value of the number of times the response j was presented with the response. Thus, in the matrix C, Cᵢᵢ=2+n_{tot,i} and Cᵢⱼ=−n_{j,i}, where n_{j,i} represents the number of times the response i was presented with the response j.

For example, if the responses A-E were presented to the users and the results were as follows:

| Response | A | B | C | D | E | Results |
|---|---|---|---|---|---|---|
| A | — | NS | S | NS | — | 1-2 |
| B | S | — | — | NS | S | 2-1 |
| C | NS | — | — | S | S | 2-1 |
| D | S | S | NS | — | NS | 2-2 |
| E | — | NS | NS | S | — | 1-2 |

where an “S” indicates that the response was selected and an “NS” indicates that the response was not selected. The corresponding matrix would be:

$$[ \begin{matrix}5 & - 1 & - 1 & - 1 & 0 \\ - 1 & 5 & 0 & - 1 & - 1 \\ - 1 & 0 & 5 & - 1 & - 1 \\ - 1 & - 1 & - 1 & 6 & - 1 \\ 0 & - 1 & - 1 & - 1 & 5\end{matrix} ] [ \begin{matrix}{score}_{A} \\ {score}_{B} \\ {score}_{C} \\ {score}_{D} \\ {score}_{E}\end{matrix} ] = [ \begin{matrix}1 / 2 \\ 3 / 2 \\ 3 / 2 \\ 1 \\ 1 / 2\end{matrix} ] .$$

The matrix may be solved to determine the scores of each of the responses.

At step 745, the service provider server 240 may transform the determined scores into a graphical representation. At step 750, the service provider server 240 may provide the graphical representation to one of the users 120A-N, such as an administrator, supervisor, decision-maker, or other similar personnel.

FIG. 8 is a flowchart illustrating the operations of determining response quality scores in the systems of FIG. 1, FIG. 2, or FIG. 3, or other systems for relative performance based valuation of responses. The steps of FIG. 8 are described as being performed by the service provider server 240. However, the steps may be performed by a processor of the service provider server 240, a processing core of the service provider server 240, any other hardware component of the service provider server 240, or any combination thereof. Alternatively the steps may be performed by an external hardware component or device, or any combination thereof.

At step 805, the service provider server 240 may retrieve one or more responses received from the users 120A-N, such as from the data store 245. At step 810, the service provider server 240 may determine the number of unique users 120A-N which the responses were presented to. At step 820, the service provider server 240 may select the first response from the set of retrieved responses. At step 825, the service provider server 240 determines whether the selected response satisfies the presentation threshold. The presentation threshold may indicate the minimum number of unique users 120A-N to whom a response must be presented to in order for the response to be eligible to receive a response quality score. The presentation threshold may be determined by an administrator, or the presentation threshold may have a default value, such as only responses in the top two-thirds of responses in terms of total presentations satisfy the presentation threshold.

If, at step 825, the service provider server 240 determines that the selected response satisfies the presentation threshold, the service provider server 240 moves to step 830. At step 830, the service provider server 240 retrieves the score of the response as calculated in FIG. 7 above. At step 840, the service provider server 240 may determine the response quality score by dividing the score of the response by the total number of unique users 120A-N to whom the response was presented. At step 850, the service provider server 240 may store the response quality score of the response in the data store 245. The service provider server 245 may also store an association between the response quality score and the response such that the response quality score can be retrieved based on the response. At step 855, the service provider server 240 may determine whether there are any additional responses which have yet to be evaluated for satisfying the presentation threshold. If, at step 855, the service provider server 240 determines that there are additional responses, the service provider server 240 moves to step 860. At step 860, the service provider server 240 may select the next response from the set of responses and repeats steps 825-855 for the next response. If, at step 825, the service provider server 240 determines that the selected response does not satisfy the presentation threshold, the service provider server 240 may move to step 855 and may determine whether any other responses have not yet been evaluated for satisfying the presentation threshold.

If, at step 855, the service provider server 240 determines that all of the responses have been evaluated for satisfying the presentation threshold, the service provider server 240 may move to step 870. At step 870, the service provider server 240 may retrieve the response quality scores and associated responses from the data store 245. At step 880, the service provider server 240 may transform the response quality scores and responses into a graphical representation. At step 890, the service provider server 240 may provide the graphical representation to the content provider A 110A who provided the initial item the responses relate to, such as through a device of the user. For example, the service provider server 240 may provide the graphical representation to a content provider A 110A, or to an administrator.

FIG. 9 is a flowchart illustrating the operations of determining a user response quality score in the systems of FIG. 1, FIG. 2, or FIG. 3, or other systems for relative performance based valuation of responses. The steps of FIG. 9 are described as being performed by the service provider server 240. However, the steps may be performed by a processor of the service provider server 240, a processing core of the service provider server 240, any other hardware component of the service provider server 240, or any combination thereof. Alternatively the steps may be performed by an external hardware component or device, or any combination thereof.

At step 910, the service provider server 240 identifies the set of users 120A-N of the collaborative environment. For example, the service provider server 240 may retrieve user data describing the users 120A-N from the data store 245. At step 920, the service provider server 240 may select the first user from the set of users 120A-N of the collaborative environment. At step 925, the service provider server 240 may determine whether the selected user satisfies the contribution threshold. The contribution threshold may indicate the minimum number of responses a user A 120A should contribute to the collaborative environment before the user A 120A is eligible to receive a user response quality score. The contribution threshold may be determined by an administrator or may have a default value. For example, a default contribution threshold may indicate that only the users 120A-N in the top two-thirds of the users 120A-N in terms of contributions to the collaborative environment satisfy the contribution threshold.

If, at step 925, the service provider server 240 determines that the selected user satisfies the contribution threshold, the service provider server 240 moves to step 930. At step 930, the service provider server retrieves the response quality scores of all of the responses provided by the selected user. At step 935, the service provider server 240 determines the user response quality score of the selected user by determining the average of the response quality scores of the responses provide by the selected user. At step 940, the service provider server 240 stores the user response quality score of the selected user in the data store 245. The service provider server 240 may also store an association between the user response quality score and the user data such that the user response quality score can be retrieved based on the user data.

At step 945, the service provider server 240 determines whether there are any additional users 120B-N which have yet to be evaluated against the contribution threshold. If, at step 945, the service provider server 240 determines there are additional users, the service provider server 240 moves to step 950. At step 950, the service provider server 240 selects the next user and repeats steps 925-945 for the next user. If, at step 925, the service provider server 240 determines that the selected user does not satisfy the contribution threshold, the service provider server 240 moves to step 945. Once the service provider server 240 have evaluated all of the users 120A-N against the contribution threshold, and determined user response quality scores for eligible users 120A-N, the service provider server 240 moves to step 960.

At step 960, the service provider server 240 retrieves the determined user response quality scores, and the associated user data from the data store 245. At step 970, the service provider server 240 transforms the user response quality scores and the associated user data into a graphical representation. At step 980, the service provider server 240 provides the graphical representation to a user, such as through a device of the user. For example, the service provider server 240 may provide the graphical representation to one of the content providers 110A-N or to an administrator.

FIG. 10 is a screenshot of a response input interface 1000 in the systems of FIG. 1, FIG. 2, or FIG. 3, or other systems for relative performance based valuation of responses. The interface 1000 includes a content 1010, a response field 1020, a save-finished selector 1030 and a save-other selector 1040. The content 1010 may display a product, such a product for sale by an online retailer, a question, such as a question being asked in a collaborative environment, or generally any content which may be reviewed by the users 120A-N.

In operation, a content provider A 110A may provide content, or an initial item, for review, such as the question, “How can we improve the end-user experience of a Rich Internet application?” The service provider server 240 may present the content 1010 to the users 120A-N for review via the interface 1000. One of the users 120A-N, such as the user A 120A may use the interface 1000 to provide a response to the content 1010. For example, in the interface 1000 the user A 120A provided the response of “Increase the amount of processing power on the database servers so that response times are improved.” The user A 120A may then save and finish by selecting the save-finished selector 1030, or save and submit other responses by selecting the save-other selector 1040.

FIG. 11 is a screenshot of a response selection interface 1100 in the systems of FIG. 1, FIG. 2, or FIG. 3, or other systems for relative performance based valuation of responses. The interface 1100 may include content 1010, instructions 1115, response field A 1120A, response field B 1120B, response selector A 1125A, and response selector B 1125B. The content 1010 may display the initial item, or content, to which the responses/reviews 1120A-B were provided. The instructions 1115 may instruct the users 120A-N on how to use the interface 1100. The responses fields 1120A-B may display responses provided by one or more of the users 120A-N.

In operation, the service provider server 240 may present pairs of responses to content 1010 to the users 120A-N, such as the user A 120A, via the interface 1100. For example, in the interface 1100, the content 1010 may be the question, “How can we improve the end-user experience of a Rich Internet application?,” the first response may be “Increase the amount of processing power on the database server so that response times are improved,” and the second response may be, “Redesign the user experience metaphor so that users are presented with a simpler set of tasks.” The user A 120A may use the response selectors 1125A-B to select one of the responses 1120A-B which the user A 120A prefers, or which the user A 120A believes most accurately responds to the content 1010.

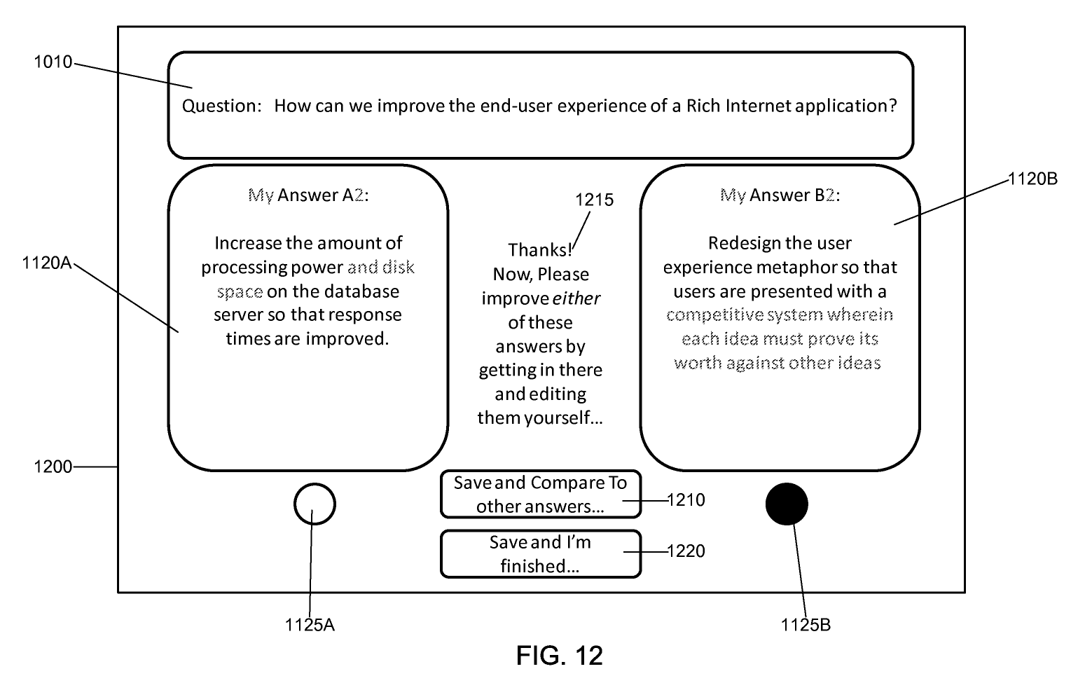

FIG. 12 is an illustration of a response modification interface 1200 in the systems of FIG. 1, FIG. 2, or FIG. 3, or other systems for relative performance based valuation of responses. The interface 1200 may include content 1010, instructions 1215, response field A 1120A, response field B 1120B, response selector A 1125A, response selector B 1125B, save-compare selector 1210, and save-finish selector 1220. The instructions 1215 may instruct the user A 120A on how to use the interface 1200.

In operation, one of the users 120A-N, such as the user A 120A, may view the responses in the response fields 1120A-B, and select the most accurate, or best, response by selecting the response selector A 1125A, or the response selector B 1125B. The user A 120A may also modify the response displayed in the response field A 1120A and/or the response displayed in the response field B 1120B. For example, the user A 120A may input modifications to the responses directly in the response fields 1120A-B. In the user interface 1200, the user A 120A modified the response displayed in response field A 1120A to read, “Increase the amount of processing power and disk space on the database server so that response times are improved,” and the user A 120A modified the response displayed in response field B 1120B to read, “Redesign the user experience metaphor so that users are presented with a competitive system wherein each idea must prove its worth against other ideas.” The user A 120A may then select the save-compare selector 1210 to save the selection and any modifications and compare against other responses. Alternatively, the user A 120A may click on the save-finish selector 1220 to exit the system 100.

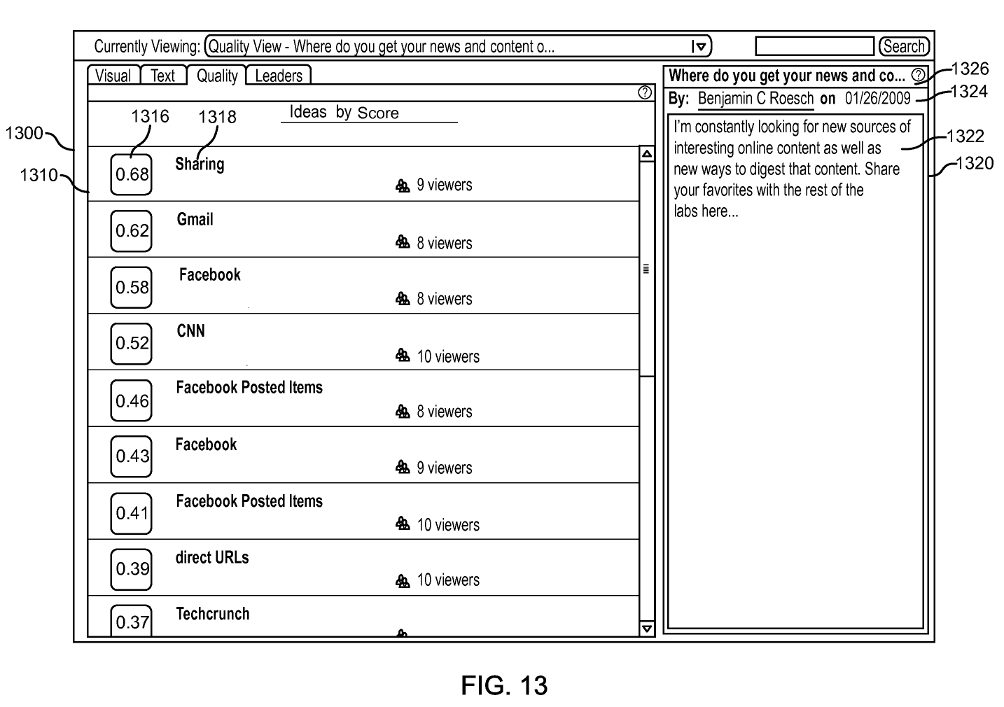

FIG. 13 is a screenshot of a reporting screen 1300 in the systems of FIG. 1, FIG. 2, or FIG. 3, or other systems for valuating users and user generated content in a collaborative environment. The reporting screen 1300 may include a report subsection 1310, and an initial item subsection 1320. The report subsection 1310 may include one or more responses 1318, or ideas, and each response 1318 may be associated with a calculated score 1318. The report subsection 1310 may also display the number of users 120A-N who viewed each response 1318.

The initial item subsection 1320 may include an item creation subsection 1324, an item title 1326, and an item description 1322. The item title 1326 may display the title of the initial item for which the responses 1318 were submitted. The item creation subsection 1324 may display one or more data items relating to the creation of the initial item, such as the user A 120A who submitted the item and the date the item was submitted on. The item description subsection 1322 may display a description of the initial item.

In operation, an administrator may view the report subsection 1310 to view the responses 1318 which received the highest calculated scores 1316. The administrator may view the initial item associated with the responses 1318 in the initial idea subsection 1320. The response quality scores 1316 may be transformed into a graphical representation to allow the administrator to quickly identify the highest calculated scores 1316. For example, the scores 1316 may be enclosed in a graphic of a box. The shading of the graphic may correlate to the calculated score 1316 such that higher scores have a lighter shading than lower scores. Alternatively or in addition the graphical representations of the calculated scores 1316 may differ by size, color, shape, or generally any graphical attribute in order to allow an administrator to quickly identify the responses with the highest response quality score.

FIG. 14 illustrates a general computer system 1400, which may represent a service provider server 240, a third party server 250, the client applications 210A-N, 220A-N, or any of the other computing devices referenced herein. The computer system 1400 may include a set of instructions 1424 that may be executed to cause the computer system 1400 to perform any one or more of the methods or computer based functions disclosed herein. The computer system 1400 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1424 (sequential or otherwise) that specify actions to be taken by that machine In a particular embodiment, the computer system 1400 may be implemented using electronic devices that provide voice, video or data communication. Further, while a single computer system 1400 may be illustrated, the term “system” shall also be taken to include any collection of systems or sub-systems that individually or jointly execute a set, or multiple sets, of instructions to perform one or more computer functions.

The computer system 1400 may include a processor 1402, such as, a central processing unit (CPU), a graphics processing unit (GPU), or both. The processor 1402 may be a component in a variety of systems. For example, the processor 1402 may be part of a standard personal computer or a workstation. The processor 1402 may be one or more general processors, digital signal processors, application specific integrated circuits, field programmable gate arrays, servers, networks, digital circuits, analog circuits, combinations thereof, or other now known or later developed devices for analyzing and processing data. The processor 1402 may implement a software program, such as code generated manually (i.e., programmed).

The computer system 1400 may include a memory 1404 that can communicate via a bus 1408. The memory 1404 may be a main memory, a static memory, or a dynamic memory. The memory 1404 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1404 may include a cache or random access memory for the processor 1402. Alternatively or in addition, the memory 1404 may be separate from the processor 1402, such as a cache memory of a processor, the system memory, or other memory. The memory 1404 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1404 may be operable to store instructions 1424 executable by the processor 1402. The functions, acts or tasks illustrated in the figures or described herein may be performed by the programmed processor 1402 executing the instructions 1424 stored in the memory 1404. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1400 may further include a display 1414, such as a liquid crystal display (LCD), an organic light emitting diode (OLED), a flat panel display, a solid state display, a cathode ray tube (CRT), a projector, a printer or other now known or later developed display device for outputting determined information. The display 1414 may act as an interface for the user to see the functioning of the processor 1402, or specifically as an interface with the software stored in the memory 1404 or in the drive unit 1406.

Additionally, the computer system 1400 may include an input device 1412 configured to allow a user to interact with any of the components of computer system 1400. The input device 1412 may be a number pad, a keyboard, or a cursor control device, such as a mouse, or a joystick, touch screen display, remote control or any other device operative to interact with the computer system 1400.

The computer system 1400 may also include a disk or optical drive unit 1406. The disk drive unit 1406 may include a computer-readable medium 1422 in which one or more sets of instructions 1424, e.g. software, can be embedded. Further, the instructions 1424 may perform one or more of the methods or logic as described herein. The instructions 1424 may reside completely, or at least partially, within the memory 1404 and/or within the processor 1402 during execution by the computer system 1400. The memory 1404 and the processor 1402 also may include computer-readable media as discussed above.

The present disclosure contemplates a computer-readable medium 1422 that includes instructions 1424 or receives and executes instructions 1424 responsive to a propagated signal; so that a device connected to a network 235 may communicate voice, video, audio, images or any other data over the network 235. Further, the instructions 1424 may be transmitted or received over the network 235 via a communication interface 1418. The communication interface 1418 may be a part of the processor 1402 or may be a separate component. The communication interface 1418 may be created in software or may be a physical connection in hardware. The communication interface 1418 may be configured to connect with a network 235, external media, the display 1414, or any other components in computer system 1400, or combinations thereof. The connection with the network 235 may be a physical connection, such as a wired Ethernet connection or may be established wirelessly as discussed below. Likewise, the additional connections with other components of the computer system 1400 may be physical connections or may be established wirelessly. In the case of a service provider server 240 or the content provider servers 110A-N, the servers may communicate with users 120A-N through the communication interface 1418.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1422 may be a single medium, or the computer-readable medium 1422 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1422 may include a solid-state memory such as a memory card or other package that houses one or more non-volatile read-only memories. The computer-readable medium 1422 also may be a random access memory or other volatile re-writable memory. Additionally, the computer-readable medium 1422 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A computer-implemented method for relative performance based valuation of responses, comprising:
receiving a plurality of responses related to an item;
presenting, to a plurality of users, pairs of responses from the plurality of responses;
for each pair of responses, receiving, from the plurality of users, a selection of one response;
calculating, by a processor, a score for each of the plurality of responses based on a number of times each of the plurality of responses was presented to the plurality of users for selection, a number of times each of the plurality of responses was selected by the plurality of users and an indication of the other responses of the plurality of responses each response was presented with; and
storing the scores of the plurality of responses.

2. The method of claim 1 wherein the calculating, by the processor, the score for each of the plurality of responses is further based on a previous score of each of the plurality of responses.

3. The method of claim 2 wherein the previous score of each of the plurality of responses are initially substantially similar.

4. The method of claim 1 wherein calculating, by the processor, the score for each of the plurality of responses further comprises calculating, by the processor, the score associated with each of the plurality of responses using a system of linear equations, wherein the number of times each of the plurality of responses was presented to the plurality of users for selection, the number of times each of the plurality of responses was selected by the plurality of users and the indication of the other responses of the plurality of responses each response was presented with comprise values used in the system of linear equations.

5. The method of claim 1 wherein the presenting, the receiving, and the calculating repeat until a rating completion threshold is satisfied, wherein the rating completion threshold is satisfied when a specified period of time elapses or when each of the plurality of responses have been presented to the plurality of users at least a specified number of times.

6. The method of claim 1 further comprising, determining the pairs of the plurality of responses to be presented to the plurality of users based on a number of times each of the plurality of responses has been presented to the plurality of users such that each of the plurality of responses are presented to the plurality of users a substantially similar number of times.

7. The method of claim 1 further comprising, determining the pairs of the plurality of responses to be presented to the plurality of users such that each response in a pair of responses has a substantially similar score.

8. A computer-implemented method for relative performance based valuation of responses, comprising:
(a) receiving a plurality of responses related to an item, wherein each of the plurality of responses is associated with a score and each of the scores are initially substantially similar;
(b) selecting a first response of the plurality of responses based on a number of times the first response has been presented to a plurality of users for selection;
(c) selecting a second response of the plurality of responses such that the score associated with the second response is substantially similar to the score associated with the first response;
(d) presenting, to a user of the plurality of users, the first response and the second response;
(e) receiving, from the user of the plurality of users, a selection of the first response or the second response;
(f) storing an indication of which of the first response or the second response was selected by the user of the plurality of users;
(g) modifying, by a processor, the score associated with each of the plurality of responses, wherein the score is modified based on the stored indication of which of the first response or the second response was selected by the user of the plurality of users and the score associated with each of the plurality of responses;
(h) repeating steps (b-g) until a rating completion threshold is satisfied; and
(i) storing the score associated with each of the plurality of responses.

9. The method of claim 8 wherein selecting the first response of the plurality of responses based on the number of times the first response has been presented to the plurality of users for selection further comprises selecting the first response of the plurality of responses where the first response has been presented to the plurality of users for selection a least number of times of any of the plurality of responses.

10. The method of claim 8 wherein the stored indication further indicates which of the first response or the second response was not selected by the user of the plurality of users.

11. The method of claim 8 wherein modifying, by the processor, the score associated with each of the plurality of responses further comprises calculating, by the processor, the score associated with each of the plurality of responses based on a number of times each of the plurality of responses was presented to the plurality of users for selection, a number of times each of the plurality of responses was selected by the plurality of users, an indication of the other responses of the plurality of responses each response was presented with, and the scores of the other plurality of responses.

12. The method of claim 11 wherein updating, by the processor, the score associated with each of the plurality of responses further comprises calculating, by the processor, the score associated with each of the plurality of responses using a system of linear equations, wherein the number of times each of the plurality of responses was presented to the plurality of users for selection, the number of times each of the plurality of responses was selected by the plurality of users, the indication of the other responses of the plurality of responses each response was presented with, and the scores of the other plurality of responses comprise values used in the system of linear equations.

13. The method of claim 8 wherein the rating completion threshold is satisfied when a specified period of time elapses or when each of the plurality of responses has been presented to the plurality of users a specified number of times.

14. A computer-implemented method for relative performance based valuation of responses, comprising:
(a) receiving a plurality of responses related to an item;
(b) calculating a plurality of scores for the plurality of responses, wherein each of the plurality of scores are initially substantially similar;
(c) selecting at least two responses of the plurality of responses, the selecting based on a number of times each of the at least two responses have been presented to the plurality of users, the score of each of the at least two responses, or a combination thereof;
(d) presenting, to a plurality of users, the at least two responses;
(e) receiving selections of one of the at least two responses from the plurality of users;
(f) determining which of the at least two responses was selected more frequently over the number of times the at least two responses were presented to the plurality of users;
(g) storing an indication of which of the at least two responses was selected more frequently;
(h) re-calculating, by a processor, the plurality of scores for the plurality of responses based on a number of times each of the plurality of responses was presented to the plurality of users for selection, a number of times each of the plurality of responses was selected by the plurality of users, an indication of the other responses of the plurality of responses each response was presented with, and the scores of the other plurality of responses;
(i) repeating steps (c)-(i) until a rating completion threshold is satisfied; and
(j) storing the plurality of scores and the plurality of responses.

15. A system for relative performance based valuation of responses, comprising:
a memory to store a plurality of responses related to an item and a plurality of scores of the plurality of responses;
an interface operatively connected to the memory, the interface operative to receive the plurality of responses and communicate with a plurality of devices of a plurality of users; and
a processor operatively connected to the memory and the interface, the processor operative to receive, via the interface, the plurality of responses related to the item, provide, to the plurality of devices of the plurality of users, pairs of responses from the plurality of responses, for each pair of responses, receive, from the plurality of devices of the plurality of users, a selection of one response, calculate the score for each of the plurality of responses based on a number of times each of the plurality of responses was presented to the plurality of users for selection, a number of times each of the plurality of responses was selected by the plurality of users and an indication of the other responses of the plurality of responses each response was presented with, and store, in the memory, the scores of the plurality of responses.

16. The system of claim 15 wherein the processor is further operative to calculate the score for each of the plurality of responses based on a previous score of each of the plurality of responses, the number of times each of the plurality of responses was presented to the plurality of users, the number of times each of the plurality of responses was selected by the plurality of users and the indication of the other responses of the plurality of responses each response was presented with.

17. The system of claim 16 wherein the previous score of each of the plurality of responses are initially substantially similar.

18. The system of claim 15 wherein the processor is further operative to calculate the score associated with each of the plurality of responses using a system of linear equations, wherein the number of times each of the plurality of responses was presented to the plurality of users, the number of times each of the plurality of responses was selected by the plurality of users and the indication of the other responses of the plurality of responses each response was presented with comprise values used in the system of linear equations.

19. The system of claim 15 wherein the processor is further operative to repeat the present, the receive and the calculate until a rating completion threshold is satisfied, wherein the rating completion threshold is satisfied when a specified period of time elapses or when each of the plurality of responses have been presented to the plurality of users at least a specified number of times.

20. The system of claim 15 wherein the processor is further operative to determine the pairs of the plurality of responses to be presented to the plurality of users based on a number of times each of the plurality of responses has been presented to the plurality of users such that each of the plurality of responses are presented to the plurality of users a substantially similar number of times.

21. The system of claim 15 wherein the processor is further operative to determine the pairs of the plurality of responses to be presented to the plurality of users such that each response in a pair of responses has a substantially similar score.

22. The system of claim 15 wherein each selection of one response comprises a preferred response of a user of the plurality of users.
